(19) United States
(12) Patent Application Publication
(10) Pub. No.: US 2016/0268030 A1
(43) Pub. Date: Sep. 15, 2016

(54) SOLENOID AND ASSOCIATED CONTROL METHOD

(71) Applicant: Eaton Corporation, Cleveland, OH (US)

(72) Inventors: Robert J. Boychuk, Troy, MI (US); John R. Barla, Macomb, MI (US); Brian J. O'Neil, Richmond, MI (US)

(21) Appl. No.: 15/158,850

(22) Filed: May 19, 2016

Related U.S. Application Data
(63) Continuation of application No. PCT/US2014/066542, filed on Nov. 20, 2014.
(60) Provisional application No. 61/906,793, filed on Nov. 20, 2013.

(51) Int. Cl. H01F 7/06

(52) U.S. Cl. CPC H01F 7/064

(57) ABSTRACT

A method for actuating a solenoid can include, when the solenoid is in the unactuated position: (i) providing a control signal at a first voltage level to the solenoid, and (ii) adjusting the control signal to a second voltage level to actuate the solenoid to the actuated position. The first voltage level can be greater than zero but less than a voltage sufficient to switch the solenoid to the actuated position. When the solenoid is in the actuated position, the control signal can be adjusted to a third voltage level (less than the second voltage level and less than a voltage insufficient to maintain the solenoid in the actuated position) to switch the solenoid to the unactuated position. The control signal can be adjusted to the first voltage level after the solenoid has returned to the unactuated position.

### CROSS-REFERENCE TO RELATED APPLICATION

This application is a continuation of International Application No. PCT/US2014/066542 filed on Nov. 20, 2014, which claims the benefit of U.S. Provisional Application No. 61/906,793, filed on Nov. 20, 2013. The entire disclosure of the above application is incorporated herein by reference.

### FIELD

The present disclosure relates generally to a solenoid and more particularly to a method of operating a solenoid by varying an electrical signal to more efficiently control actuation of the solenoid.

### BACKGROUND

An electrically actuated solenoid can be switched between an actuated position and an unactuated position based on an electrical control signal. Typically, the solenoid will be in the unactuated position when the control signal is at a low voltage (e.g., 0 volts). In order to actuate the solenoid, i.e., switch the solenoid to the actuated position, a control signal at a high voltage (e.g., 5-20 volts) is provided to the solenoid. The solenoid will remain in the actuated position as long as the control signal remains at the high voltage, and will return to the unactuated position when the control signal returns to the low voltage.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In some aspects of the present disclosure, a method for actuating an electrically controlled solenoid is disclosed. The method can include providing a control signal at a first voltage level to the solenoid when the solenoid is in an unactuated position. The first voltage level can be greater than zero but less than a first threshold voltage level corresponding to a voltage sufficient to switch the solenoid to an actuated position. The method can also include adjusting the control signal to a second voltage level to actuate the solenoid to the actuated position. The second voltage level can be greater than or equal to the first threshold voltage level. Additionally, the method can include adjusting the control signal to a third voltage level when the solenoid is in the actuated position. The third voltage level can be less than the second voltage level but greater than a second threshold voltage level corresponding to a voltage insufficient to maintain the solenoid in the actuated position. Furthermore, the method can include adjusting the control signal to a fourth voltage level when the solenoid is in the actuated position to switch the solenoid to the unactuated position. The fourth voltage level can be less than the third voltage level and the second threshold voltage level. The method can also include adjusting the control signal to the first voltage level after the solenoid has returned to the unactuated position.

In additional or alternative aspects of the present disclosure, a method for actuating an electrically controlled solenoid is disclosed. The method can include, when the solenoid is in the unactuated position: (i) providing a control signal at a first voltage level to the solenoid, and (ii) adjusting the control signal to a second voltage level to actuate the solenoid to the actuated position. The first voltage level can be greater than zero but less than a first threshold voltage level corresponding to a voltage sufficient to switch the solenoid to the actuated position. The second voltage level can be greater than or equal to the first threshold voltage level. The method can further include, when the solenoid is in the actuated position, adjusting the control signal to a third voltage level to switch the solenoid to the unactuated position. The third voltage level can be less than the second voltage level and less than a second threshold voltage level corresponding to a voltage insufficient to maintain the solenoid in the actuated position. Furthermore, the method can include adjusting the control signal to the first voltage level after the solenoid has returned to the unactuated position.

In various aspects of the present disclosure, another method for actuating an electrically controlled solenoid is disclosed. The method can include, when the solenoid is in the unactuated position: (i) providing a control signal at a first voltage level to the solenoid, (ii) adjusting the control signal to a second voltage level, and (iii) adjusting the control signal to a third voltage level to actuate the solenoid to the actuated position. The first voltage level can be approximately zero. The second voltage level can be greater than zero but less than a first threshold voltage level corresponding to a voltage sufficient to switch the solenoid to the actuated position. The third voltage level can be greater than or equal to the first threshold voltage level. The method can also include, when the solenoid is in the actuated position, adjusting the control signal to the first voltage level to switch the solenoid to the unactuated position. The first voltage level can be less than a second threshold voltage level corresponding to a voltage insufficient to maintain the solenoid in the actuated position.

In some aspects of the present disclosure, a solenoid is disclosed. The solenoid can be operated according to the method described above.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of an example solenoid according to some aspects of the present disclosure in an unactuated position;

FIG. 2 is a schematic diagram of the example solenoid of FIG. 1 in an actuated position; and

FIG. 3 is a graph illustrating an example solenoid control signal and a position of its corresponding solenoid according to some aspects of the present disclosure.

### DETAILED DESCRIPTION

As mentioned above, an electrically actuated solenoid can be switched between an actuated position and an unactuated position based on an electrical control signal. In an unactuated position, the solenoid may have a first threshold voltage level corresponding to a voltage sufficient to switch the solenoid to an actuated position. When the electrical control signal provided to the solenoid in the unactuated position is at a voltage level below this first threshold voltage level, the solenoid will remain in the unactuated position. When the electrical control signal provided to the solenoid in the unactuated position is at a voltage level greater than or equal to the first threshold voltage level, the solenoid will switch to the actuated position.

Similarly, in the actuated position the solenoid may have a second threshold voltage level corresponding to a voltage insufficient to maintain the solenoid in the actuated position. When the electrical control signal provided to the solenoid in the actuated position is at a voltage level greater than or equal to this second threshold voltage level, the solenoid will remain in the actuated position. When the electrical control signal provided to the solenoid in the actuated position is at a voltage level less than this second threshold voltage level, the solenoid will switch to the unactuated position.

In some aspects, the voltage sufficient to switch the solenoid from the unactuated position to the actuated position (the first threshold voltage level) is greater than the voltage sufficient to maintain the solenoid in the actuated position. Thus, the power consumed by the solenoid may be reduced by adjusting the control signal to a voltage level below the first threshold voltage level when the solenoid is in, and is intended to stay in, the actuated position.

Furthermore, the solenoid may exhibit a “switching time” that is sub-optimal or undesirable. That is, there may be an elapsed time between a first time (at which the control signal is switched to the high voltage level to actuate the solenoid) to a second time (at which the solenoid actually reaches the actuated position) that is greater than that desired. Additionally or alternatively, there may be an elapsed time between a third time (at which the control signal is switched to the low voltage level to switch the solenoid to the unactuated position) to a fourth time (at which the solenoid actually reaches the unactuated position) that is greater than that desired. A relatively long switching time may be undesirable, and may decrease the performance of the solenoid.

A solenoid and associated control method that reduces power consumption and/or the switching time is desirable and can improve the performance of the solenoid.

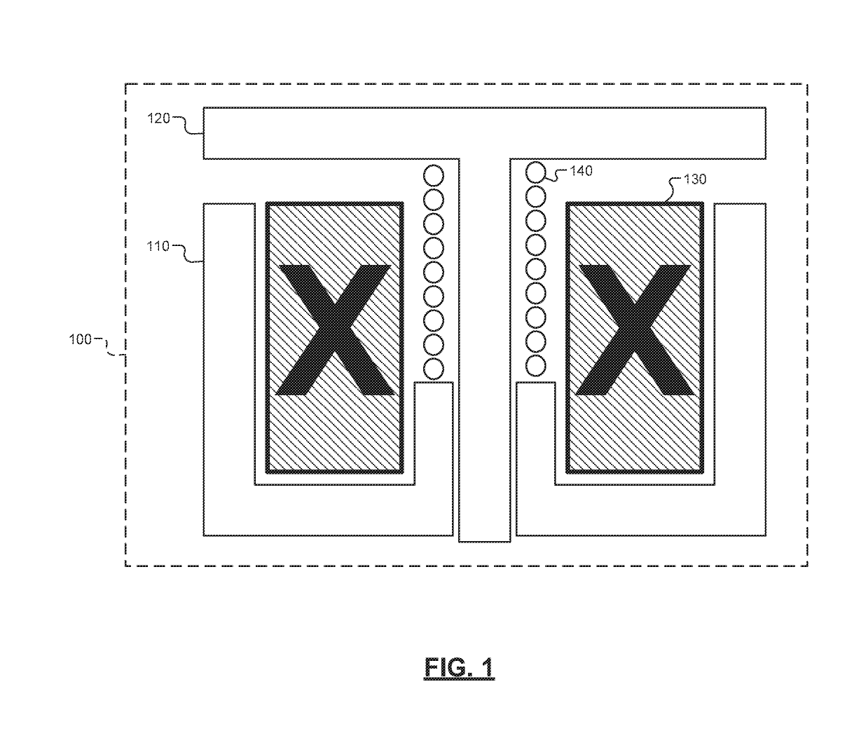

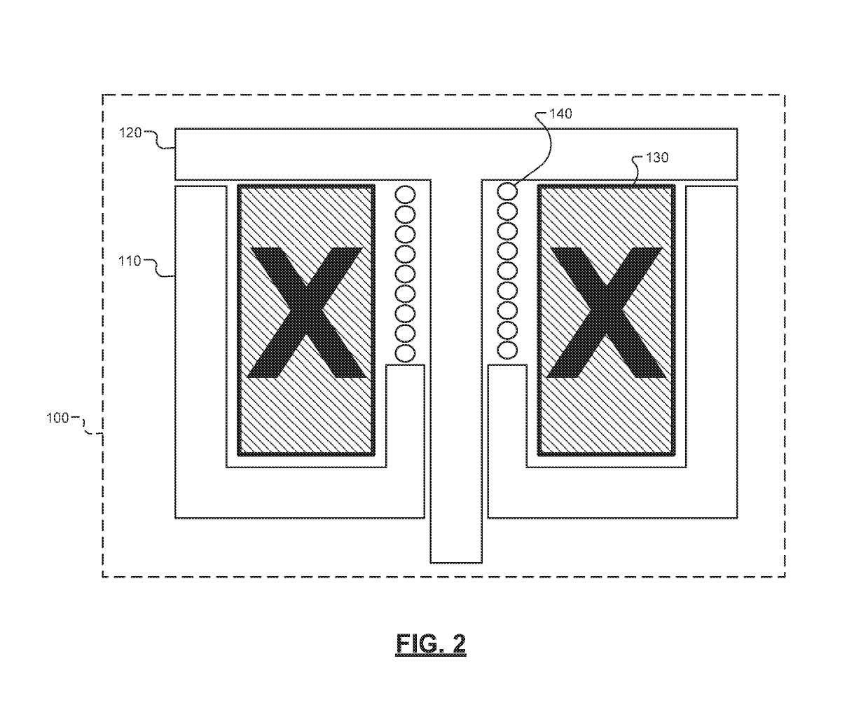

Referring now to FIGS. 1 and 2, an example solenoid 100 is illustrated. The example solenoid 100 can include a body portion 110, a plunger 120, a coil winding 130, and a spring 140. The solenoid 100 can be actuated or switched between the unactuated position (FIG. 1) and the actuated position (FIG. 2). When electricity is provided to the coil winding 130 (e.g., a control signal as described below), the plunger 120 will move from the unactuated position (FIG. 1) and the actuated position (FIG. 2), and vice versa. It should be appreciated that the illustrated solenoid 100 is merely an example, and solenoids having alternative constructions are within the scope of the present disclosure.

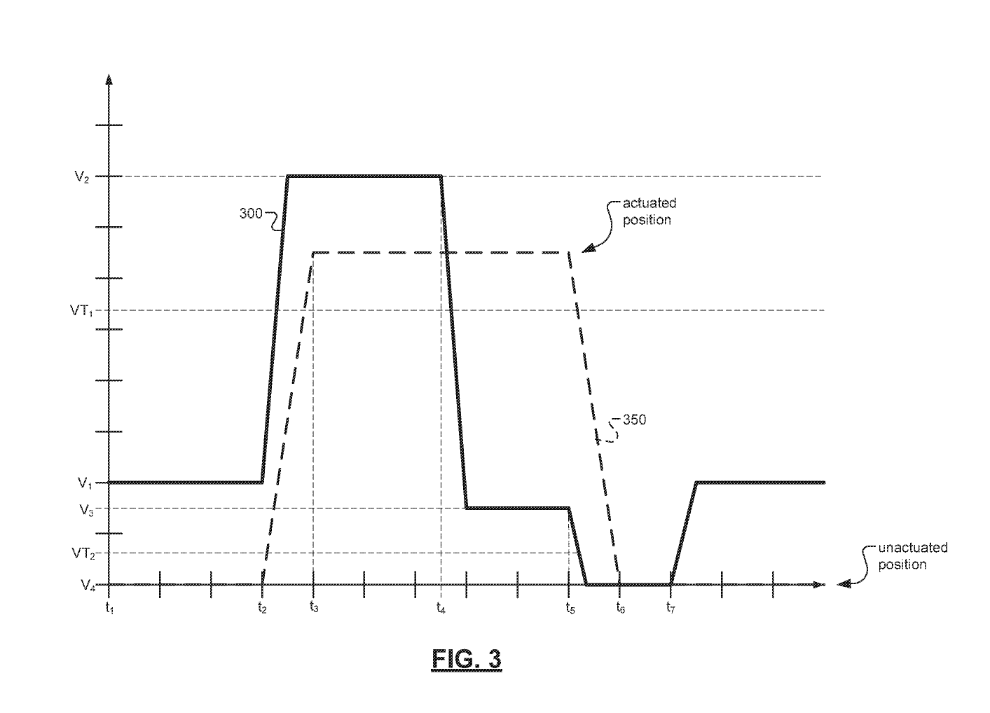

Referring now to FIG. 3, an example solenoid control signal 300 and a solenoid position 350 of its corresponding solenoid according to some aspects of the present disclosure is illustrated. As described more fully below, the control signal 300 is adjusted between a first voltage level (V₁), a second voltage level (V₂), a third voltage level (V₃), and a fourth voltage level (V₄). The various voltage levels (V₁-V₄) can be based on the switching voltage thresholds of the solenoid. As mentioned above, the solenoid will have a first threshold voltage level (VT₁) corresponding to the voltage sufficient to switch the solenoid from the unactuated to the actuated position. Additionally, the solenoid will have a second threshold voltage level (VT₂) corresponding to the voltage insufficient to maintain the solenoid in the actuated position, which can be less than the first threshold voltage level (VT₁). The various voltage levels (V₁-V₄) can be selected to obtain the desired performance (power consumption, switching time, etc.) of the solenoid.

At a first time (t₁), the control signal 300 at a first voltage level (V₁) is provided to the solenoid. In some aspects, the first voltage level V₁ is greater than zero but less than the first threshold voltage level (VT₁). Further, at the first time (t₁) the solenoid position 350 is in the unactuated position. At a second time (t₂), the control signal 300 is adjusted to a second voltage level (V₂) greater than or equal to the first threshold voltage level (VT₁). At the second time (t₂), the solenoid position 350 is in the unactuated position. The solenoid will begin switching to the actuated position when the control signal 300 reaches (or exceeds) the first voltage threshold level (VT₁), and will reach the actuated position at a third time (t₃). It should be appreciated that, although FIG. 3 shows the solenoid position 350 beginning to change at the second time (t₂), there may be some delay between the time at which the control signal 300 is adjusted (the second time (t₂)) and the time at which the solenoid position begins to change. The first voltage level (V₁) can be selected to reduce the switching time (e.g., the elapsed time between t₂ and t₃) of the solenoid, while maintaining an acceptable level of power consumption.

As mentioned above, the solenoid will reach the actuated position at the third time (t₃). At a fourth time (t₄) after the solenoid reaches the actuated position at the fourth time (t₄), the control signal 300 can be adjusted to a third voltage level (V₃). The third voltage level (V₃) can be less than the second voltage level (V₂) but greater than the second threshold voltage level (VT₂) corresponding to the voltage insufficient to maintain the solenoid in the actuated position. In this manner, the solenoid may be maintained in the actuated position, while reducing the power consumption of the solenoid (as compared to providing the control signal at the second voltage level (V₂)). Further, in some aspects, the third voltage level (V₃) is approximately equal to the first voltage level (V₁).

In order to switch the solenoid to the unactuated position, the control signal 300 is adjusted at a fifth time (t₅) to a fourth voltage level (V₄) that is less than the third voltage level (V₃) and less than the second voltage threshold level (VT₂). In some aspects, the fourth voltage level (V₄) is approximately equal to zero volts. The solenoid will begin switching to the unactuated position when the control signal 300 reaches (or becomes less than) the second voltage threshold level (VT₂), and will reach the actuated position at a sixth time (t₆). It should be appreciated that, although FIG. 3 shows the solenoid position 350 beginning to change at the fifth time (t₅), there may be some delay between the time at which the control signal 300 is adjusted (the fifth time (t₅)) and the time at which the solenoid position begins to change.

As mentioned above, the solenoid will return to the unactuated position at the sixth time (t₆). At a seventh time (t₇) after the solenoid reaches the unactuated position at the sixth time (t₆), the control signal 300 can be adjusted to the first voltage level (V₁). In this manner, the solenoid will be ready to may be maintained in the actuated position, while reducing the power consumption of the solenoid (as compared to providing the control signal at the second voltage level (V₂)).

The foregoing description of the aspects of the present teachings has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for actuating an electrically controlled solenoid, comprising:
providing a control signal at a first voltage level to the solenoid when the solenoid is in an unactuated position, the first voltage level being greater than zero but less than a first threshold voltage level corresponding to a voltage sufficient to switch the solenoid to an actuated position;
adjusting the control signal to a second voltage level to actuate the solenoid to the actuated position, the second voltage level being greater than or equal to the first threshold voltage level;
adjusting the control signal to a third voltage level when the solenoid is in the actuated position, the third voltage level being less than the second voltage level but greater than a second threshold voltage level corresponding to a voltage insufficient to maintain the solenoid in the actuated position;
adjusting the control signal to a fourth voltage level when the solenoid is in the actuated position to switch the solenoid to the unactuated position, the fourth voltage level being less than the third voltage level and less than the second threshold voltage level; and
adjusting the control signal to the first voltage level after the solenoid has returned to the unactuated position.

2. The method of claim 1, wherein the first voltage level is approximately equal to the third voltage level.

3. The method of claim 1, wherein the fourth voltage level is approximately equal to zero volts.

4. The method of claim 1, wherein the first voltage level is not equal to the third voltage level.

5. The method of claim 1, wherein the first threshold voltage level is greater than the second threshold voltage level.

6. The method of claim 1, wherein providing the control signal at the first voltage level to the solenoid when the solenoid is in the unactuated position comprises maintaining the control signal at the first voltage level while the solenoid is in the unactuated position for a pre-charge period of time.

7. A method for actuating an electrically controlled solenoid from an unactuated position to an actuated position, comprising:
when the solenoid is in the unactuated position:
providing a control signal at a first voltage level to the solenoid, the first voltage level being greater than zero but less than a first threshold voltage level corresponding to a voltage sufficient to switch the solenoid to the actuated position, and
adjusting the control signal to a second voltage level to actuate the solenoid to the actuated position, the second voltage level being greater than or equal to the first threshold voltage level;
when the solenoid is in the actuated position:
adjusting the control signal to a third voltage level to switch the solenoid to the unactuated position, the third voltage level being less than the second voltage level and less than a second threshold voltage level corresponding to a voltage insufficient to maintain the solenoid in the actuated position; and
adjusting the control signal to the first voltage level after the solenoid has returned to the unactuated position.

8. The method of claim 7, wherein providing the control signal at the first voltage level to the solenoid when the solenoid is in the unactuated position comprises maintaining the control signal at the first voltage level while the solenoid is in the unactuated position.

9. The method of claim 8, wherein adjusting the control signal to the first voltage level after the solenoid has returned to the unactuated position comprises increasing a voltage of the control signal such that the solenoid is pre-charged to reduce an actuation time of the solenoid from the unactuated to the actuated position.

10. The method of claim 9, wherein the third voltage level is approximately equal to zero volts.

11. The method of claim 9, wherein the first voltage level is not equal to the third voltage level.

12. The method of claim 7, wherein the first threshold voltage level is greater than the second threshold voltage level.

13. The method of claim 7, wherein providing the control signal at the first voltage level to the solenoid when the solenoid is in the unactuated position comprises maintaining the control signal at the first voltage level while the solenoid is in the unactuated position.

14. The method of claim 7, wherein the third voltage level is approximately equal to zero volts.

15. The method of claim 7, wherein adjusting the control signal to the first voltage level after the solenoid has returned to the unactuated position comprises increasing a voltage of the control signal such that the solenoid is pre-charged to reduce an actuation time of the solenoid from the unactuated to the actuated position.

16. A method for actuating an electrically controlled solenoid, comprising:
when the solenoid is in the unactuated position:
providing a control signal at a first voltage level to the solenoid, the first voltage level being approximately zero,
adjusting the control signal to a second voltage level, the second voltage level being greater than zero but less than a first threshold voltage level corresponding to a voltage sufficient to switch the solenoid to the actuated position, and
adjusting the control signal to a third voltage level to actuate the solenoid to the actuated position, the third voltage level being greater than or equal to the first threshold voltage level; and
when the solenoid is in the actuated position:
adjusting the control signal to the first voltage level to switch the solenoid to the unactuated position, the first voltage level being less than a second threshold voltage level corresponding to a voltage insufficient to maintain the solenoid in the actuated position.

17. The method of claim 16, further comprising adjusting the control signal to the second voltage level after the solenoid has returned to the unactuated position such that the solenoid is pre-charged to reduce an actuation time of the solenoid from the unactuated to the actuated position.

18. The method of claim 17, wherein adjusting the control signal to the second voltage level comprises maintaining the control signal at the second voltage level while the solenoid is in the unactuated position for a pre-charge period of time.

19. The method of claim 16, wherein the first threshold voltage level is greater than the second threshold voltage level.

20. The method of claim 16, wherein adjusting the control signal to the second voltage level comprises maintaining the control signal at the second voltage level while the solenoid is in the unactuated position for a pre-charge period of time.
